(19) United States
(12) Patent Application Publication
(10) Pub. No.: US 2010/0270318 A1
(43) Pub. Date: Oct. 28, 2010

(54) PANEL ASSEMBLY FOR CARGO CONTAINERS

(76) Inventors: Habib J. Dagher, Veazie, ME (US); Anthony M. Viselli, Bangor, ME (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/767,454

(22) Filed: Apr. 26, 2010

Related U.S. Application Data
(60) Provisional application No. 61/172,475, filed on Apr. 24, 2009.

(51) Int. Cl. B65D 90/02; B23P 17/04

(52) U.S. Cl. 220/660; 29/428

(57) ABSTRACT

A panel assembly configured for mounting to a container includes a panel body having a major surface and a plurality of side surfaces. The major surface defines edge regions near an intersection of the major surface and the side surfaces. An edge member is attached to an edge region of the panel body.

### CROSS REFERENCE TO RELATED APPLICATIONS

This application claims benefit of U.S. Provisional Application No. 61/172,475 filed Apr. 24, 2009, which is incorporated herein by reference.

This invention was made with U.S. government support under Department of Homeland Security Science and Technology Directorate Contract No. N66001-08-D-0010. The United States government has certain rights in this invention.

### BACKGROUND

Various embodiments of a panel assembly for a cargo container are described herein. In particular, the embodiments described herein relate to improved panel assemblies for air cargo containers.

There has been a recognition that the United States is at risk of the delivery of weapons of mass destruction to its seaport and airports by enemies employing a strategy of hiding such a weapon in a shipping container. Various schemes have been proposed for x-raying containers or otherwise examining containers as they are loaded on ships or planes in ports and airports, especially foreign ports and airports. Such schemes, however, can be very limited in effectiveness since they can be defeated with x-ray shielding, vulnerable to compromise by rogue employees and the contents of the containers altered after they are loaded in a foreign port.

Air cargo containers, also known as unit load devices (ULDs) are containers used to load luggage, freight, mail, and the like on wide-body aircraft and some specific narrow-body aircraft. ULDs allow a large quantity of cargo to be bundled into a single unit. Since this leads to fewer units to load, ULDs save ground crews time and effort and helps prevent delayed flights. ULDs may be manufactured by attaching wall panels to a metal frame, which defines the desired shape of the container. The panels may be constructed from wood, fiberglass, fiberboard, metal, or combinations of these materials.

Sensors may be attached or embedded in the wall panels of cargo or shipping containers to deter intrusion or tampering. U.S. Patent Application Publication No. 2008/0211669 A1 to Habib J. Dagher et al., incorporated herein by reference, discloses various embodiments of a panel comprising multi-layered composite material that can be welded to other components. For example, the composite panel may be welded to the frame of a container or to other like panels to form a tamper-resistant container, such as a shipping container. The composite panel may also contain embedded processors and sensors that can detect intrusion into or tampering of the container.

U.S. patent application Ser. No. 12/642,054 to Habib J. Dagher et al., incorporated herein by reference, discloses panels and panel connectors having an integrated breach detection system for shipping containers. The panels and connectors have embedded electrical circuits. Multiple panels in a container may be electrically connected to each other with the connectors.

### SUMMARY

The present application describes various embodiments of a panel assembly. In one embodiment, a panel assembly configured for mounting to a container includes a panel body having a major surface and a plurality of side surfaces. The major surface defines edge regions near an intersection of the major surface and the side surfaces. An edge member is attached to an edge region of the panel body.

Other advantages of the panel assembly will become apparent to those skilled in the art from the following detailed description, when read in light of the accompanying drawings.

### BRIEF DESCRIPTION OF THE DRAWINGS

FIG. 1 is a perspective view of an air cargo container.

FIG. 2 is a plan view of a first embodiment of a panel assembly illustrated in FIG. 1.

FIG. 2A is a perspective view of the panel body illustrated in FIG. 2.

FIG. 2B is a cross-sectional view of an alternated embodiment of the panel body illustrated in FIGS. 2 and 2A.

FIG. 3A is a cross-sectional view of a portion of the panel assembly illustrated in FIG. 2, taken along the line 3-3.

FIG. 3B is a cross-sectional view of a portion of a second embodiment of the panel assembly illustrated in FIG. 2.

FIG. 3C is a cross-sectional view of a portion of a third embodiment of the panel assembly illustrated in FIG. 2.

FIG. 3D is a cross-sectional view of a portion of a fourth embodiment of the panel assembly illustrated in FIG. 2.

FIG. 3E is a cross-sectional view of a portion of a fifth embodiment of the panel assembly illustrated in FIG. 2.

FIG. 3F is a cross-sectional view of a portion of a sixth embodiment of the panel assembly illustrated in FIG. 2.

FIG. 3G is a cross-sectional view of a portion of a seventh embodiment of the panel assembly illustrated in FIG. 2.

FIG. 4 is a plan view of an eighth embodiment of the panel assembly illustrated in FIG. 2.

FIG. 5 is a plan view of a ninth embodiment of the panel assembly illustrated in FIG. 2.

FIG. 6 is an exploded cross-sectional view of a portion of the two-piece frame illustrated in FIG. 1, shown with the panel assemblies removed.

FIG. 7 is a cross-sectional view of a first portion of the two-piece frame illustrated in FIG. 1, taken along the line 7-7 and showing a tenth embodiment of the panel assembly illustrated in FIG. 2.

FIG. 8 is a cross-sectional view of a second portion of the two-piece frame illustrated in FIG. 1, taken along the line 8-8.

FIG. 9 is a cross-sectional view of an alternate embodiment of the two-piece frames illustrated in FIGS. 1, 6, and 8.

FIG. 10 is a schematic perspective view of the air cargo container illustrated in FIG. 1, showing the electrical connections between panel assemblies.

FIG. 11 is an enlarged cross-sectional plan view of a portion of a first embodiment of a floor panel assembly taken along the line 11-11.

FIG. 12 is an enlarged cross-sectional plan view of a portion of a second embodiment of the floor panel assembly illustrated in FIG. 11.

FIG. 13 is an enlarged cross-sectional plan view of a portion of a third embodiment of the floor panel assembly illustrated in FIG. 11.

FIG. 14 is an enlarged cross-sectional plan view of a portion of a fourth embodiment of the floor panel assembly illustrated in FIG. 11.

FIG. 15 is an enlarged cross-sectional plan view of a portion of a fifth embodiment of the floor panel assembly illustrated in FIG. 11.

FIG. 16 is a cross-sectional view of an eleventh embodiment of the panel assembly illustrated in FIG. 2.

FIG. 17 is a cross-sectional view of a portion of two of the panel assemblies illustrated in FIG. 16 mounted in the two-piece frame illustrated in FIG. 6.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

As used in the description and the appended claims, the phrase “unit load devices (ULDs)” also known as “air cargo containers,” and further known as “AKE-type air cargo containers” is defined as containers used to load luggage, freight, mail, and the like on wide-body aircraft and some specific narrow-body aircraft.

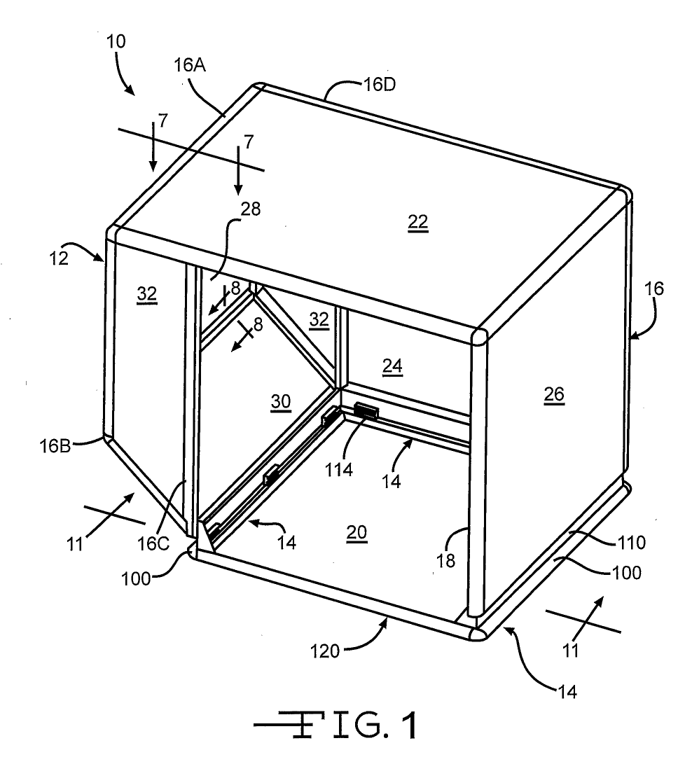

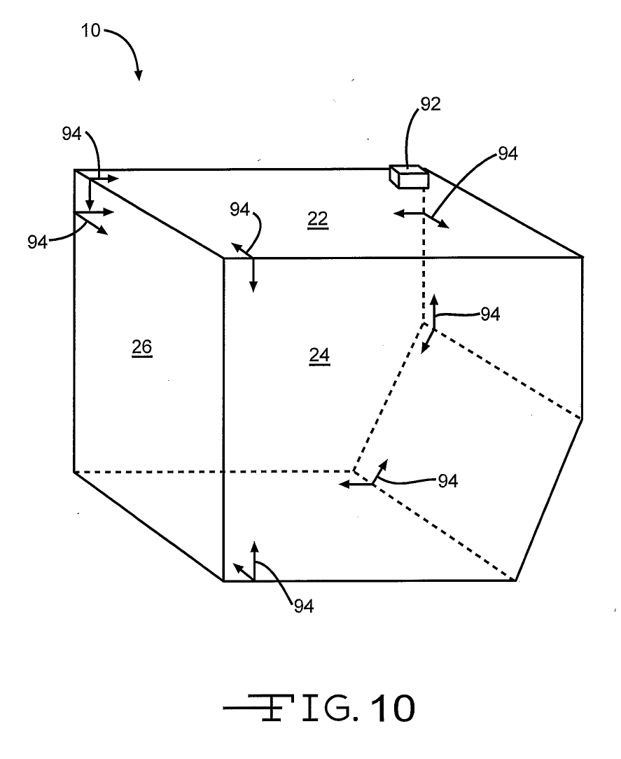

Referring now to FIG. 1, there is illustrated generally at 10 an air cargo container or ULD. The ULD 10 illustrated in FIG. 1 is an AKE-type air cargo container. It will be understood however, that the panel assemblies and panel bodies described herein may be used with any type of ULD. The ULD 10 includes a frame 12 having a plurality of floor frame members 14, and upper frame members 16, including the upper frame members 16A, 16B, 16C, and 16D. The ULD 10 further includes a cargo opening 18 and a plurality of panel assemblies, the various embodiments of which are described in detail below. The frame 12 may be formed from any substantially rigid material, such as aluminum, steel, composites, plastic, and other metals and non-metals. As shown in FIGS. 6 and 7, and described in detail below, the illustrated frame members 16 are two part frame members.

The panel assemblies include a base or floor 20, a roof 22, a back wall 24 opposite the cargo opening 18, an inboard side wall 26, an upper outboard side wall 28, a lower outboard side wall 30, and shear panels 32. A door (not shown) may be mounted within the cargo opening 18. It will be understood that the door may be any of the known types of doors used in ULDs, such as a fabric door, a roll-top style door, a hinged door, or any other desired door. It will be further understood that the door may be formed from any of the embodiments of the panel bodies and panel assemblies described herein.

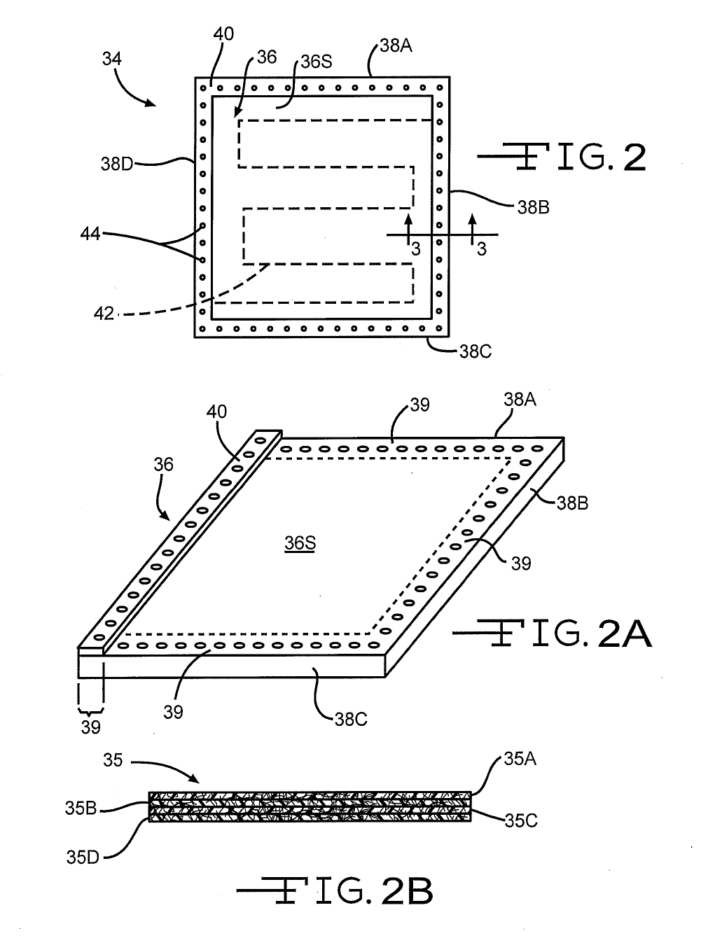

Referring now to FIGS. 2 and 2A, a first embodiment of a panel assembly is illustrated at 34. The illustrated panel assembly 34 may be used as any one of the panel assemblies 20, 22, 24, 26, 28, 30, and 32 illustrated in FIG. 1. The illustrated panel assembly 34 includes a panel body 36 having a first major surface 36S, a second major surface 37S, opposite the first major surface 36S, and a plurality of side surfaces 38A, 38B, 38C, and 38D. As shown in FIG. 2A, the first major surface 36S defines edge regions 39 near the intersection of the first major surface 36S and the side surfaces 38A, 38B, 38C, and 38D. A reinforcement or edge member 40 is attached to the edge regions 39 of the panel body 36. The edge member 40 may be attached to the panel body 36 by any desired means, such as with an adhesive. Examples of suitable adhesives include epoxy, methyl methacrylate, polyester, and thermoplastic adhesives.

The illustrated panel body 36 has a square shape. It will be understood however, that the panel body 36 may have any other desired shape, such as rectangular, triangular, trapezoidal, and other shapes having straight and/or arcuate edges suitable for use with a variety of shapes of ULDs 10. In one embodiment, the panel body 36 is composed of a fiber-reinforced polymer composite material. The reinforced polymer structure may comprise multiple layers of unidirectional fabric in various orientations randomly oriented fabric or woven fabric encased in a resin matrix. In one embodiment, the reinforced polymer structure may consist of E-glass/thermoplastic composite (“E-glass Composite”), E-glass Composite has specific strength, impact, and durability properties that exceed those of conventional steel.

Alternatively, the panel body may be formed in layers. In one example shown in FIG. 2B, the panel body 35 is formed having four layers: a first fire resistant layer 35A, a 0-layer 35B, a 90-layer 35C, and second fire resistant layer 35D. As used herein, the “fire resistant layer” is polypropylene film, the “0-layer” is an E-glass layer with a longitudinal fiber orientation along a first axis, and the “90-layer” is an E-glass layer with a longitudinal fiber orientation along a second axis, perpendicular to the first axis. It will be understood that other configurations of layers may be provided in order to obtain the desired performance properties of the panel body 36. It will be further understood that panels formed from other materials, such as non-composite material, aluminum, or other metals and non-metals may be used in lieu of the composite panel body 36 described above.

Additionally, the panel body 36 may include an optional embedded electrical circuit or sensors, shown schematically at 42. Various embodiments of the circuit 42 are described in detail in U.S. Patent Application Publication No. 2008/0211669 A1, to Habib J. Dagher et al., incorporated herein by reference. It will be understood that the circuit 42 may be applied to the surface of the panel body 36 and/or embedded within the material of the panel body 36. Other circuits or sensors in addition to those described in U.S. Patent Application Publication No. 2008/0211669 A1, to Habib J. Dagher et al., may be used within the panel bodies and panel assemblies described herein.

U.S. patent application Ser. No. 12/642,054 to Habib J. Dagher et al., also incorporated herein by reference, discloses panels and panel connectors having an integrated breach detection system for shipping containers. The panels and connectors have embedded electrical circuits. Multiple panels in a container may be electrically connected to each other with the connectors.

In addition to the sensors described in U.S. Patent Application Publication No. 2008/0211669 A1, to Habib J. Dagher et al., and U.S. patent application Ser. No. 12/642,054 to Habib J. Dagher et al., detectors or sensors for sensing other hazardous and dangerous material, such as chemical and biological agents, may be embedded within the panel body 36.

In the illustrated embodiment, the edge member 40 has a rectangular shape corresponding to the shape of the panel body 36. The illustrated edge member 40 is disposed in the edge regions 39. It will be understood that the edge member 40 need not extend around the entire periphery of the panel body 36 and may be formed in sections and selectively attached to the panel body 36 in any combination of one or more of the edge regions 39, such as illustrated in FIG. 2A.

In the illustrated embodiment, the edge member 40 is formed from KEVLAR®. Alternatively, other aramid and para-aramid fiber products, metal such as aluminum, carbon fiber, and S-Glass thermoplastic composites may be used. Additionally, if desired, the edge member 40 may be formed from the same material used to form the panel body 36. The illustrated edge member 40 is shown as a single layer of material. Alternatively, the edge member 40 may comprise multiple layers of one or more materials.

In the embodiments illustrated, the edge member 40 has a strength and stiffness greater than the panel body 36, and therefore the edge member 40 provides increased strength and stiffness to the panel assembly 34 within the edge regions 39 where the edge member 40 is attached, and where the fastener apertures 44, described below, will be formed. It will be understood however, that the edge member 40 need not have a strength and stiffness greater than the panel body 36.

As shown in FIG. 2, a plurality of rivet or fastener receiving apertures 44 are formed through the edge member 40 and the panel body 36. In the illustrated embodiment, the apertures 44 are configured to receive rivets 46, as described below. The apertures 44 may be formed by any desired method, such as by drilling.

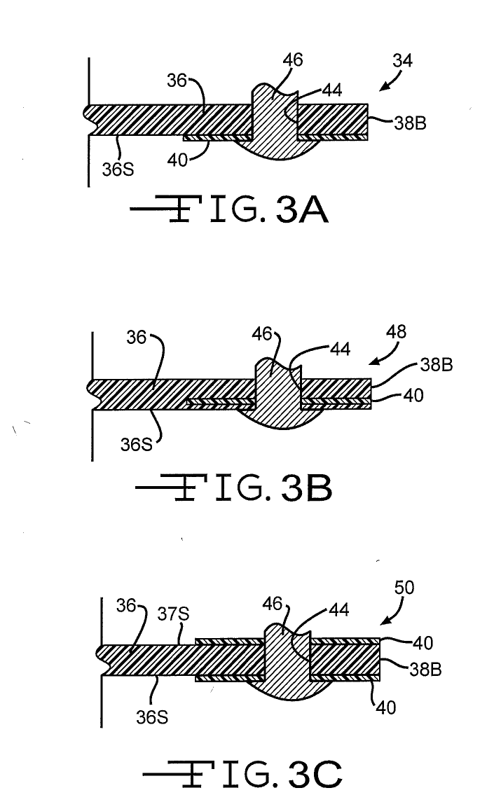

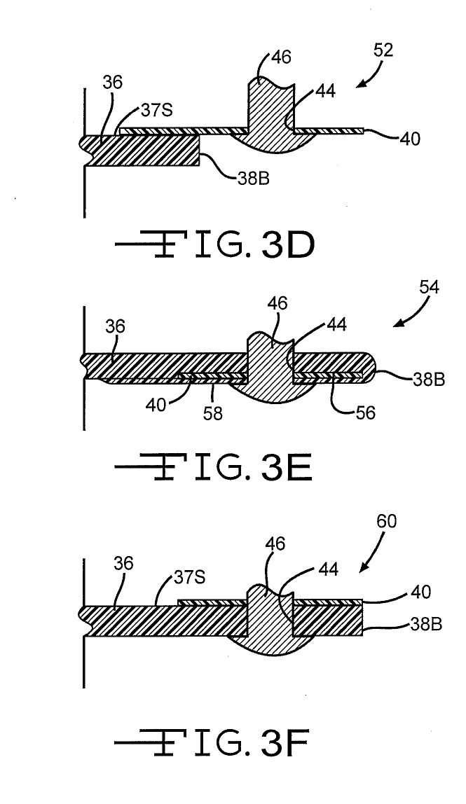

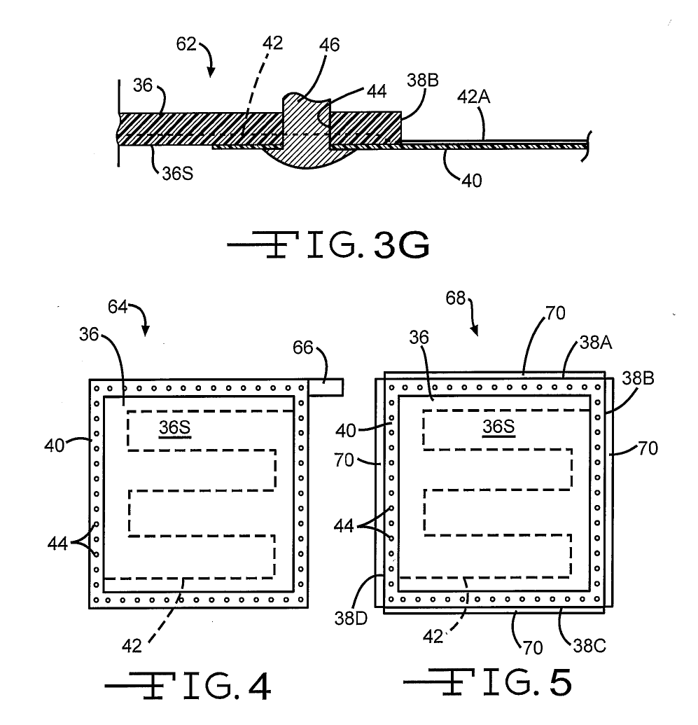

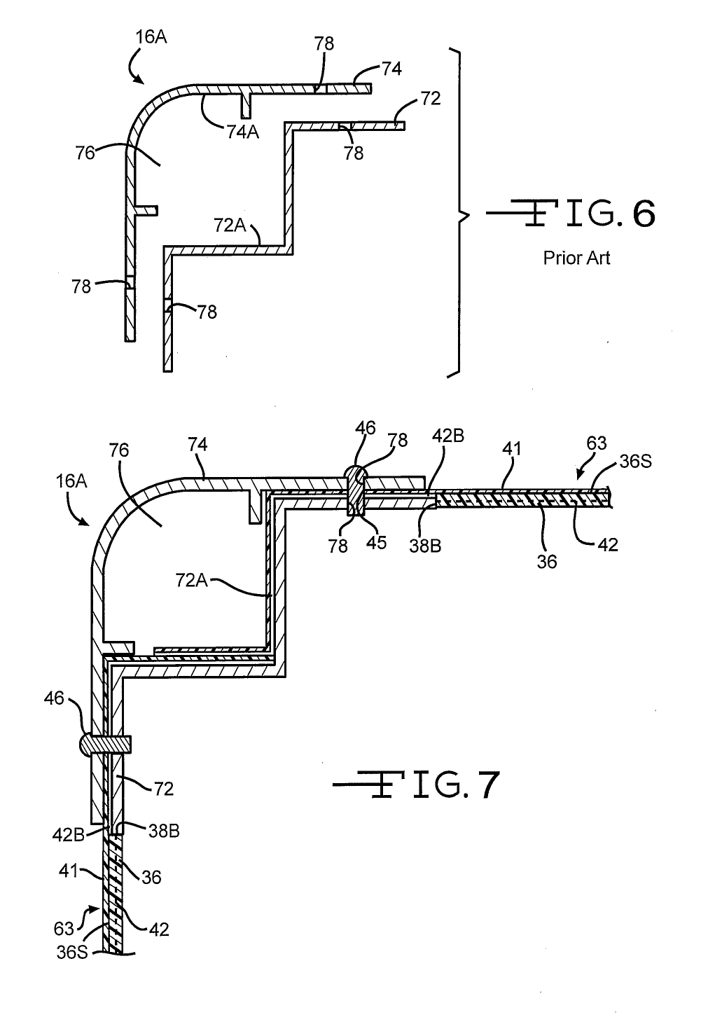

Referring now to FIG. 3A, a portion of the panel assembly is shown at 34. The panel assembly 34 includes the edge member 40 mounted the first major surface 36S of the panel body 36. A rivet 46 is shown within the aperture 44. The panel 36 and the edge member 40 may be joined together using an adhesive as described above.

A portion of a second embodiment of the panel assembly is illustrated at 48 in FIG. 3B. The panel assembly 48 is similar to the panel assembly 34 and includes the edge member 40 embedded within a longitudinally extending slot formed in the side surface 38B of the panel body 36. A rivet 46 is shown within the aperture 44. The panel 36 and the edge member 40 may be joined together using an adhesive as described above.

A portion of a third embodiment of the panel assembly is illustrated at 50 in FIG. 3C. The panel assembly 50 is similar to the panel assembly 34 and includes the edge member 40 mounted on the first major surface 36S and a second major surface 37S, opposite the first major surface 36S, of the panel body 36. A rivet 46 is shown within the aperture 44. The panel 36 and the edge member 40 may be joined together using an adhesive as described above.

A portion of a fourth embodiment of the panel assembly is illustrated at 52 in FIG. 3D. The panel assembly 52 is similar to the panel assembly 34 and includes the edge member 40 mounted to the second major surface 37S of the panel body 36. In the panel assembly 52, a portion of the edge member 40 extends outwardly of the side surface 38B of the panel body 36. A rivet 46 is shown within an aperture 44 formed only in the edge member 40. The panel 36 and the edge member 40 may be joined together using an adhesive as described above.

A portion of a fifth embodiment of the panel assembly is illustrated at 54 in FIG. 3E. The panel assembly 54 is similar to the panel assembly 34 and includes the edge member 40 embedded within a longitudinally extending opening 56 in panel body 36. In the illustrated embodiment, the opening 56 is formed by wrapping a portion 58 of the panel body 36 around the edge member 40. A rivet 46 is shown within the aperture 44. The panel 36 and the edge member 40 may be joined together using an adhesive as described above.

A portion of a sixth embodiment of the panel assembly is illustrated at 60 in FIG. 3F. The panel assembly 60 includes the edge member 40 mounted the second major surface 37S of the panel body 36. A rivet 46 is shown within an aperture 44 formed only in the edge member 40.

A portion of a seventh embodiment of the panel assembly is illustrated at 62 in FIG. 3G. The panel assembly 62 includes the edge member 40 mounted the first major surface 36S of the panel body 36. In the panel assembly 62, a portion of the edge member 40 extends outwardly of the side surface 38B of the panel body 36. A portion of and is mounted to the edge member 40. A rivet 46 is shown within the aperture 44. The electrical circuit 42 is shown schematically extending longitudinally through the panel body 36. An exposed portion 42A of the circuit 42 extends outward of the panel body 36. The exposed portion 42A of the circuit 42 allows the circuit 42 to be electrically connected to circuits or sensors in adjacent panel assemblies or to electrical devices, such as computers, transmitters, and alarms (not shown). The exposed portion 42A of the circuit 42 may also be electrically connected to a connector (not shown) for further connection to circuits or sensors in adjacent panel assemblies or to electrical devices. It will be understood that any of the embodiments of the panel body illustrated in FIGS. 3A through 3G, inclusive, may include the embedded or attached electrical circuit 42 and may further include the exposed portion 42A of the circuit 42 extending outward of the panel body.

Referring now to FIG. 4, an eighth embodiment of the panel assembly is illustrated at 64. The illustrated panel assembly 64 may be used as any one of the panel assemblies 20, 22, 24, 26, 28, 30, and 32 illustrated in FIG. 1. The electrical circuit 42 is embedded in the panel body 36. The illustrated panel assembly 64 includes the edge member 40 attached to the first major surface 36S of panel body 36. Apertures 44 are formed through the edge member 40 and the panel body 36. An electrical connector 66 extends outward from a corner of the panel assembly 64 and allows the circuit 42 to be electrically connected to circuits or sensors in adjacent panel assemblies or to other electrical devices as described above. It will be understood that any desired number of the electrical connector 66 may extend outward from any desired portion of the panel assembly 64.

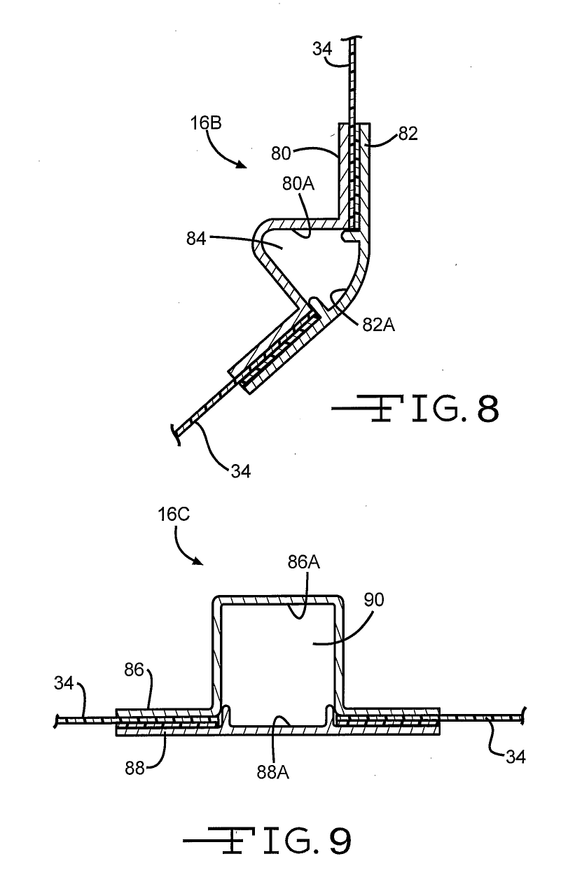

Referring now to FIG. 5, a ninth embodiment of the panel assembly is illustrated at 68. The illustrated panel assembly 68 may be used as any one of the panel assemblies 20, 22, 24, 26, 28, 30, and 32 illustrated in FIG. 1. The electrical circuit 42 is embedded in the panel body 36. The illustrated panel assembly 68 includes the edge member 40 attached to the first major surface 36S of panel body 36. Apertures 44 are formed through the edge member 40 and the panel body 36. Longitudinally extending electrical connectors 70 extend outward from each of the side surfaces 38A, 38B, 38C, and 38D of the panel body 36 and allow for electrical contact with the circuit 42 around the entire perimeter of the panel assembly 68. Although four electrical connectors 70 are shown extending outwardly of each of the side surfaces 38A, 38B, 38C, and 38D, it will be understood that the electrical connectors 70 may extend outwardly from any combination of one or more of the side surfaces 38A, 38B, 38C, and 38D.

Referring now to FIG. 6, the upper frame member 16A is illustrated prior to assembly, i.e., without the panel assemblies. In FIG. 7, the upper frame member 16A is illustrated assembled with panel assemblies 63, described below. The illustrated frame member 16A is a two-part frame member having an elongated inner frame 72 and an elongated outer frame 74. The outer frame 74 defines an outside corner of the ULD 10. A space 76 is defined between an outwardly facing surface 72A of the inner frame 72 and an inwardly facing surface 74A of the outer frame 74. Fastener receiving apertures 78 are formed through the inner and outer frames 72 and 74.

Referring now to FIG. 7, a tenth embodiment of the panel assembly is illustrated at 63 and shown mounted within the upper frame member 16A. The illustrated panel assembly 63 includes the edge member 41 mounted to the first major surface 36S of the panel body 36. The electrical circuit 42 is embedded in the panel body 36. In the panel assembly 63, a portion of the edge member 41 extends outwardly of the side surface 38B of the panel body 36. An exposed portion 42B of the circuit 42 extends outward of the panel body 36 and is mounted to the edge member 41. The edge member 40 and attached circuit portion 42B extends into the space 76 along the outwardly facing surface 72A of the inner frame 72 and is electrically connected to the edge member 40 of an adjacent panel assembly 63. A rivet 46 is shown within the aperture 78 of the inner and outer frames 72 and 74, and the aperture 45 formed through the edge member 41. In the illustrated embodiment, the edge member 40 conforms to the shape of the outwardly facing surface 72A of the inner frame 72. Alternatively, the edge member 40 and/or the exposed portion 42B of the circuit 42 may have any other desired shape within the space 76. It will be understood that any of the embodiments of the panel assemblies illustrated in FIGS. 3A through 3G, inclusive, may be mounted within the upper frame member 16A as shown in FIG. 7.

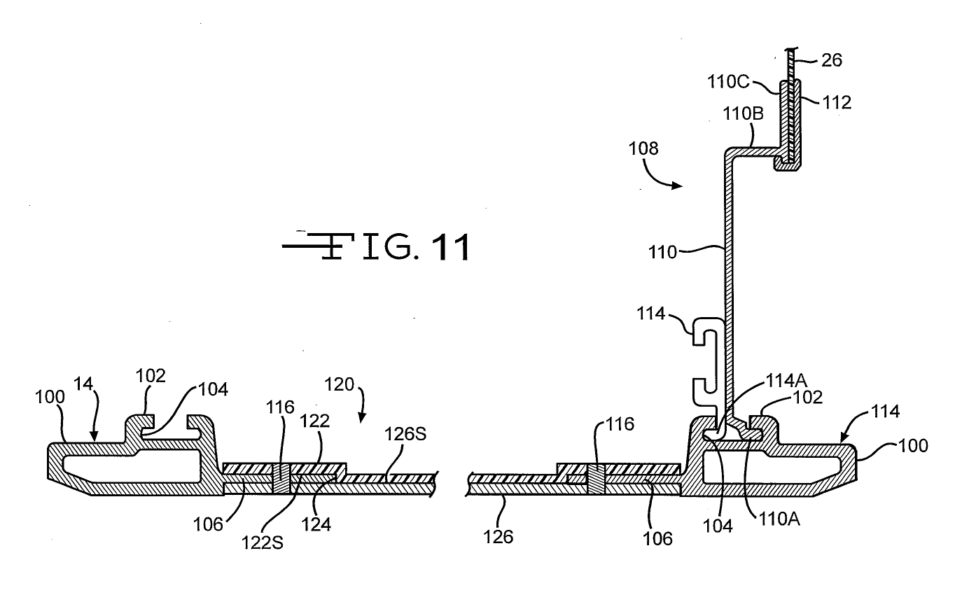

Referring now to FIG. 8, a first alternate embodiment of the upper frame member is illustrated at 16B. The illustrated upper frame member 16B is shown assembled with the panel assemblies 34. The illustrated frame member 16B is a two-part frame member having an elongated inner frame 80 and an elongated outer frame 82. The outer frame 82 defines an outside corner of the ULD 10. A space 84 is defined between an outwardly facing surface 80A of the inner frame 80 and an inwardly facing surface 82A of the outer frame 82. Fastener receiving apertures (not shown) may be formed through the inner and outer frames 80 and 82.

Referring now to FIG. 9, a second alternate embodiment of the upper frame member is illustrated at 16C. The illustrated upper frame member 16C is shown assembled with the panel assemblies 34. The illustrated frame member 16C is a two-part frame member having an elongated inner frame 86 and an elongated outer frame 88. The outer frame 88 defines an outside corner of the ULD 10. A space 90 is defined between an outwardly facing surface 86A of the inner frame 86 and an inwardly facing surface 88A of the outer frame 88. Fastener receiving apertures (not shown) may be formed through the inner and outer frames 86 and 88.

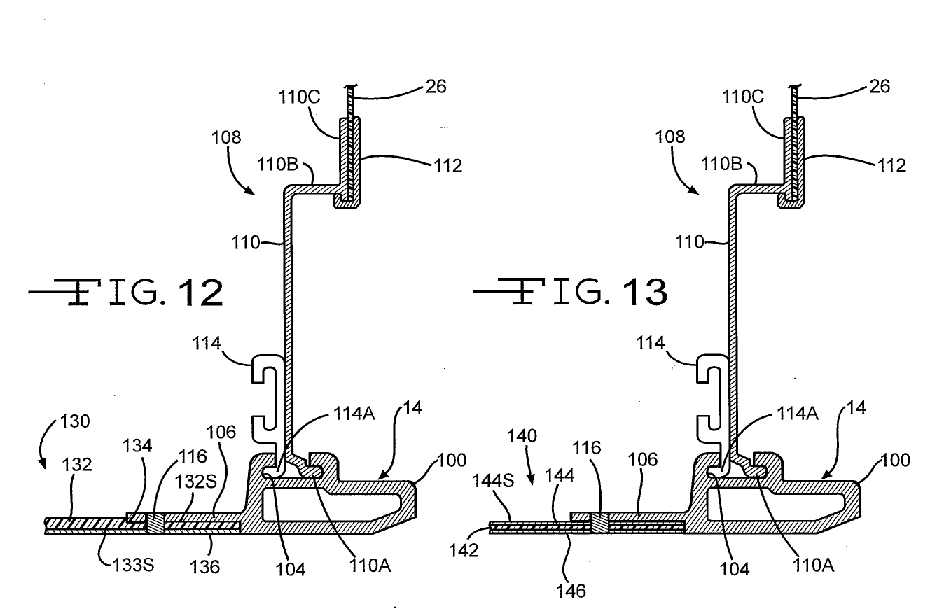

Referring now to FIG. 10, the ULD 10 is illustrated schematically and shows representative locations of electrical connections 94 between the panel assemblies, 20, 22, 24, 26, 28, 30, and 32, also illustrated in FIG. 1. A power supply 92 may be mounted to the ULD 10 to provide an electrical current to flow through the electrical circuits 42, as shown in FIG. 2, between panel assemblies via the electrical connections 94. It will be understood that the power supply 92 may be located within the ULD 10, or outside the ULD 10, as shown. Alternatively, the power supply 92 may be located within one or more of the spaces 76, 84, and 90. It will be further understood that the ULD 10 may be configured to be electrically connected to other similarly equipped ULDs. The power supply 94 thus may be configured to supply power to more than one ULD. The ULD 10 may also be connected to a remotely located power supply.

Referring now to FIG. 11, a portion of the floor frame member 14 is shown. The floor frame member 14 is also shown in FIG. 1. The floor frame member 14 includes an elongated tubular member 100. An upwardly facing surface of the tubular member 100 includes an elongated mounting member 102 defining an elongated mounting groove 104. A floor flange 106 extends inwardly from the tubular member 100. A floor frame wall assembly 108 extends outwardly (upwardly when viewing FIG. 11) of the tubular member 100. The floor frame wall assembly 108 includes a substantially flat body 110 having a first or lower end 110A, a second horizontally extending portion 110B, and third or upper end 110C. The first end 110A is mounted within the groove 104. A panel assembly, such as the inboard side wall 26 is mounted between the upper end 110C and an elongated mounting plate 112. In the illustrated embodiment, the mounting plate 112 has a substantially J-shaped cross-sectional shape and is mounted to the upper end 110C of the body 110 of the floor frame wall assembly 108.

A plurality of tie-down members 114 extend inwardly from the floor frame wall assembly 108. In the illustrated embodiment, the tie-down members 114 have a substantially C-shaped cross-sectional shape and have a first or lower end 114A. The first end 114A is mounted within the groove 104. In the embodiment illustrated in FIG. 1, three tie-down members 114 are mounted to the floor frame wall assembly 108 of each floor frame member 14. It will be understood that any desired number of tie-down members 114 may be provided. The floor frame members 14 and the tie-down members 114 may be formed from any substantially rigid material, such as aluminum, steel, composites, plastic, and other metals and non-metals.

A portion of a first embodiment of a floor panel assembly is shown at 120 in FIG. 11. The floor panel assembly 120 includes a first or inner layer 122 and a second or outer layer 126. The inner layer 122 is substantially flat but includes a notch 124. The inner layer 122 is mounted to the floor frame member 14 such that a portion of the outwardly facing major surface 122S of the inner layer 122 and the notch 124 engage the flange 106. The outer layer 126 is substantially flat and is mounted to the floor frame member 14 such that a portion of the inwardly facing major surface 126S engages the flange 106 and a portion of the inwardly facing major surface 126S engages a portion of the outwardly facing major surface 122S of the inner layer 122. Fasteners, such as the rivets 116 extend through the inner layer 122, the flange 106, and the outer layer 126 to fasten the inner layer 122, the flange 106, and the outer layer 126 together. If desired, an adhesive may be disposed between the inner layer 122 and the outer layer 126. Examples of suitable adhesives include epoxy, methyl methacrylate, polyester, and thermoplastic adhesives. It will be understood that any adhesive capable of forming a bond between the inner and outer layers 122 and 126, respectively, having sufficient strength to withstand the forces exerted by loads encountered during shipping operations may be used.

In the illustrated embodiment, the inner layer 122 is formed fiber-reinforced polymer composite material having six layers of E-glass and a thickness of about 0.05 inches (1.27 mm). Alternatively, the composite material may have within the range of from about 2 layers to about 10 layers or E-glass and a thickness within the range of from about 0.01 inches (0.423 mm) to about 2.11 inches (2.12 mm). The illustrated embodiment of the outer layer 126 is formed from aluminum for impact and/or scuffing protection. The outer layer may have a thickness of about 0.138 inches (3.5 mm). Alternatively, the outer layer 126 may have a thickness within the range of from about 0.01 inches (2.5 mm) to about 0.20 inches (5 mm).

A portion of a second embodiment of the floor panel assembly is illustrated at 130 in FIG. 12. The floor panel assembly 130 is similar to the panel assembly 120 and includes a first or inner layer 132 and a second or outer layer 136. The inner layer 132 is substantially flat but includes a notch 134. The inner layer 132 is mounted to the floor frame member 14 such that a portion of the inwardly facing major surface 132S of the inner layer 132 and the notch 134 engage the flange 106. The outer layer 136 is substantially flat and is mounted to the outwardly facing major surface 133S of the inner layer 132. Fasteners, such as the rivets 116 extend through the flange 106, the inner layer 132, and the outer layer 136 to fasten the flange 106, the inner layer 132, and the outer layer 136 together. If desired, an adhesive may be disposed between the inner layer 132 and the outer layer 136. It will be understood that any adhesive capable of forming a bond between the inner and outer layers 132 and 136, respectively, having sufficient strength to withstand the forces exerted by loads encountered during shipping operations may be used.

In the illustrated embodiment the inner layer 132 is formed fiber-reinforced polymer composite material having a thickness of about 0.10 inches (2.5 mm). Alternatively, the composite material may have a thickness within the range of from about 0.04 inches (1.0 mm) to about 0.20 inches (5.0 mm). The illustrated embodiment of the outer layer 136 is formed from aluminum for impact protection. The outer layer may have a thickness of about 0.040 inches (1.0 mm). Alternatively, the outer layer 136 may have a thickness within the range of from about 0.02 inches (0.5 mm) to about 0.20 inches (5.0 mm).

A portion of a third embodiment of the floor panel assembly is illustrated at 140 in FIG. 13. The floor panel assembly 140 is similar to the panel assembly 120 and includes a first or core layer 142 between two second layers. The second layers define an inner layer 144 and an outer layer 146. Each of the illustrated layers 142, 144, and 146 are substantially flat and may be bonded together with an adhesive or rivets. The floor panel assembly 140 is mounted to the floor frame member 14 such that a portion of the inwardly facing major surface 144S of the inner layer 144 engages the flange 106. Fasteners, such as the rivets 116 extend through the flange 106 and the layers 142, 144, and 146 to fasten the flange 106 and layers 142, 144, and 146 together. If desired, an adhesive may be disposed between the layers 142, 144, and 146. It will be understood that any adhesive capable of forming a bond between the core layer 142 and each of the second layers 144 and 146 having sufficient strength to withstand the forces exerted by loads encountered during shipping operations may be used.

In the illustrated embodiment, the core layer 142 is formed fiber-reinforced polymer composite material having a thickness of about 0.06 inches (1.52 mm). Alternatively, the composite material may have a thickness within the range of from about 0.01 inches (0.254 mm) to about 0.2 inches (5.08 mm). The illustrated embodiment of the inner and outer layers 144 and 146 are formed from aluminum for impact protection. The inner and outer layers 144 and 146 may have a thickness of about 0.032 inches (0.81 mm). Alternatively, the inner and outer layers 144 and 146 may have a thickness within the range of from about 0.01 inches (0.254 mm) to about 0.0787 inches (2.0 mm).

A portion of a fourth embodiment of the floor panel assembly is illustrated at 150 in FIG. 14. The floor panel assembly 150 is similar to the panel assembly 120 but includes only a single floor panel 152. The floor panel assembly 150 is mounted to the floor frame member 14 such that a portion of the inwardly facing major surface 152S of the floor panel 152 engages the flange 106. Fasteners, such as the rivets 116 extend through the flange 106 and the floor panel 152 to fasten the flange 106 and the floor panel 152 together.

In the illustrated embodiment the floor panel 152 is formed fiber-reinforced polymer composite material having a thickness of about 0.138 inches (3.5 mm). Alternatively, the composite material may have a thickness within the range of from about 0.04 inches (1.0 mm) to about 0.2 inches (5.0 mm).

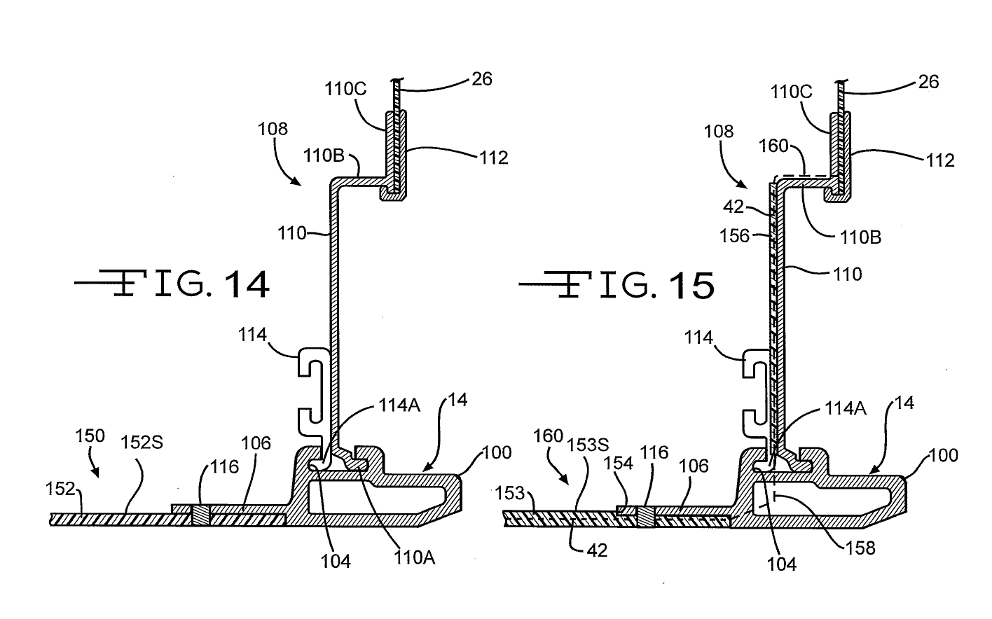

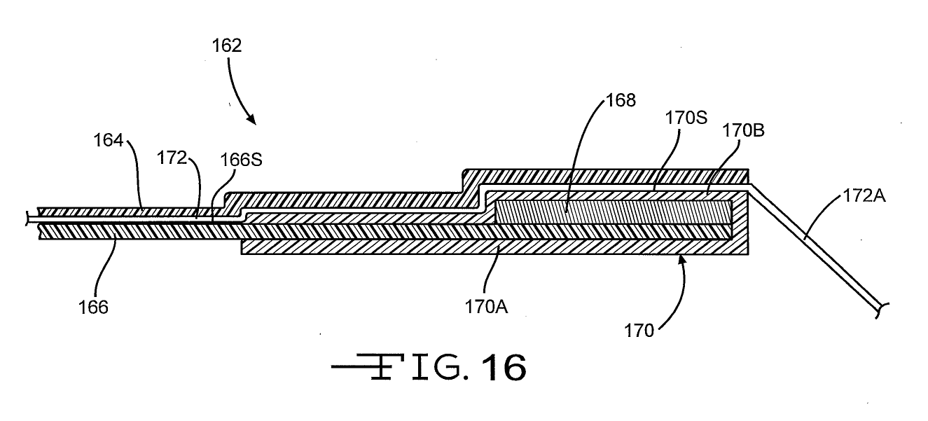

A portion of a fifth embodiment of the floor panel assembly is illustrated at 160 in FIG. 15. The floor panel assembly 150 is similar to the panel assembly 150 and includes only a single floor panel 153. The floor panel 153 is substantially flat but includes a notch 154. The floor panel assembly 150 is mounted to the floor frame member 14 such that a portion of the inwardly facing major surface 153S of the floor panel 153 and the notch 154 engage the flange 106. Fasteners, such as the rivets 116 extend through the flange 106 and the floor panel 153 to fasten the flange 106 and the floor panel 153 together.

In the embodiment illustrated in FIG. 15, an elongated floor frame panel 156 is mounted to an inwardly facing surface of the body 110 of each of the three floor frame wall assemblies 108. The panels 156 may be substantially the same as the panel body 36 and include the embedded electrical circuit or sensors 42. The panels 156 define a protective collar around the three sides of the frame 12 having the floor frame members 14. A first electrical connector 158 extends through a portion of the floor frame member 14 and connects the electrical circuit 42 of the floor panel 153 to the electrical circuit 42 of the floor frame panel 156. Similarly, a second electrical connector 160 extends through a portion of the floor frame wall assembly 108 and connects the electrical circuit 42 of the floor frame panel 156 to an electrical circuit (not shown in FIG. 15) of the panel assembly defining the inboard side wall 26. The elongated floor frame panel 156 may be mounted to an inwardly facing surface of the body 110 by fasteners, such as rivets (not shown). Alternatively, an adhesive may be disposed between the frame panel 156 and the body 110. It will be understood that any adhesive capable of forming a bond between the frame panel 156 and the body 110 having sufficient strength to withstand the forces exerted by loads encountered during shipping operations may be used. The floor frame panel 156 may also be held in place with the tie down members 114, with or without an adhesive, during assembly of the floor frame members 14.

In the illustrated embodiment the floor panel 153 is formed fiber-reinforced polymer composite material having about 20 layers of E-glass and a thickness of about 0.157 inches (4.0 mm). Alternatively, the composite material may have within the range of from about 4 layers to about 40 layers of E-glass and a thickness within the range of from about 0.0314 inches (0.798 mm) to about 0.314 inches (8.0 mm). In the illustrated embodiment the floor frame panel 156 is formed fiber-reinforced polymer composite material having a thickness of about 0.02 inches (0.508 mm). Alternatively, the composite material may have a thickness within the range of from about 0.01 inches (0.254 mm) to about 0.2 inches (5.0 mm).

It will be understood that each of the composite panels 122, 132, 142, 152, and 153 illustrated in FIGS. 11, 12, 13, 14, and 15 respectively, and the composite panel 156 illustrated in FIG. 15, may include the embedded electrical circuit or sensors 42. It will be further understood that the various embodiments of the panel assemblies, and the respective components of each, illustrated in FIGS. 2 through 15 are not drawn to scale. The various layers and components may be shown enlarged for clarity. Additionally, other composite floor panel assemblies may be used, such as a floor panel assembly having a foam core bonded between two panels formed of a fiber-reinforced polymer composite material, as described in detail above.

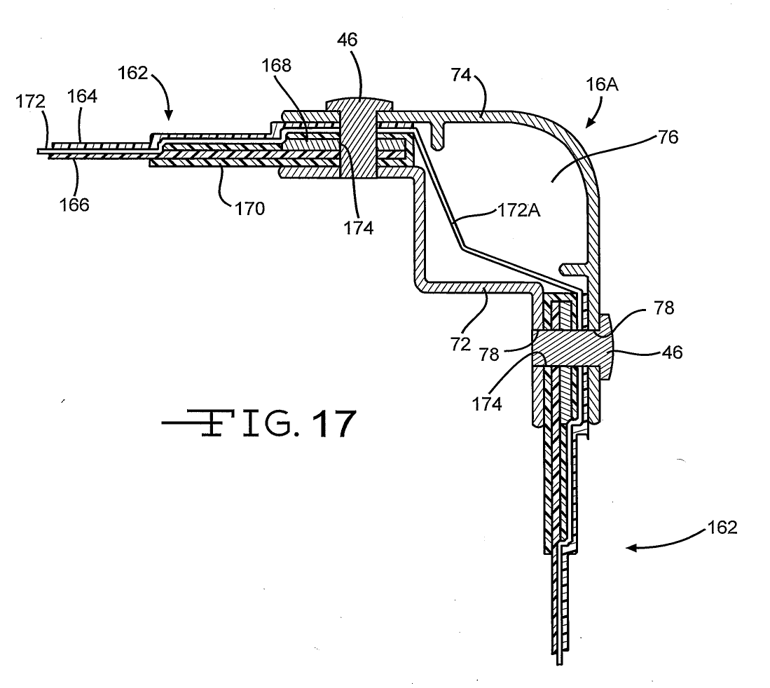

Referring now to FIG. 16, a cross-sectional schematic view of an eleventh embodiment of the panel assembly is illustrated at 162. The panel assembly 162, and its respective components illustrated in FIG. 16, is not drawn to scale. The various layers and components may be shown enlarged for clarity.

The panel assembly 162 includes a reinforcement layer 168 mounted to a first composite layer 166. The reinforcement layer 168 and the first composite layer 166 are wrapped by a second composite layer 170. The wrapped second composite layer 170 defines a first portion 170A and a second portion 170B of the second composite layer 170. A third composite layer 164 is mounted to a portion of a major surface 166S of the first composite layer 166 and a portion of a major surface 170S of the second portion 170B of the second composite layer 170. The panel 162 includes an embedded electrical circuit or sensors 172. An exposed portion 172A of the circuit 172 extends outward of the panel assembly 162. It will be understood the circuit 172 may also be embedded in any of the composite layers 164, 166, and 170. If desired, an adhesive may be disposed between the composite layers 164, 166, and 170, and the reinforcement layer 168. Examples of suitable adhesives include epoxy, methyl methacrylate, polyester, and thermoplastic adhesives. It will be understood that any adhesive capable of forming a bond between the composite layers 164, 166, and 170, having sufficient strength to withstand the forces exerted by loads encountered during shipping operations may be used. Alternatively, the composite layers 164, 166, and 170 may be formed simultaneously, thereby eliminating the need for adhesive.

Referring now to FIG. 17, two of the panel assemblies 162 are illustrated mounted in the two-piece frame 16A, also shown in FIG. 6. A rivet 46 is shown within the apertures 78 of the inner and outer frames 72 and 74, and the aperture 174 formed through the panel assembly 162. The exposed portion 172A of the circuit 1722 extends outward of the panel assembly 162 and into the space 76 where it is electrically connected to the exposed portion 172A of an adjacent panel assembly 162.

The principle and mode of operation of the panel assembly have been described in its preferred embodiment. However, it should be noted that the panel assembly described herein may be practiced otherwise than as specifically illustrated and described without departing from its scope.

What is claimed is:

1. A panel assembly configured for mounting to a container, the panel assembly comprising:
a panel body having a major surface and a plurality of side surfaces, the major surface defining edge regions near an intersection of the major surface and the side surfaces; and
an edge member attached to an edge region of the panel body.

2. The panel assembly according to claim 1, wherein a plurality of fastener receiving apertures are formed through the edge member and the panel body.

3. The panel assembly according to claim 1, wherein the panel body is formed from a first material and the edge member is formed from a second material stronger than the first material.

4. The panel assembly according to claim 3, wherein the panel body is formed from resin reinforced with glass and the edge member is formed from resin reinforced with one of an aramid material, a para-aramid material, aluminum, and E-glass.

5. The panel assembly according to claim 1, wherein an array of sensors is embedded within the panel body.

6. The panel assembly according to claim 5, wherein the array of sensors includes one of an electrical sensor, an optical sensor, a chemical agent sensor, and a biological agent sensor.

7. The panel assembly according to claim 6, wherein the panel assembly includes an electrical connector connected to the array of sensors and extending outward of the panel body.

8. The panel assembly according to claim 1, wherein the edge member is bonded to a surface of the panel body; and
wherein a portion of the edge member extends outward of the panel body.

9. The panel assembly according to claim 1, wherein the edge member is mounted within panel body at a peripheral edge of the panel body.

10. A container having a plurality of the panel assemblies according to claim 1, and further comprising a frame.

11. The container according to claim 11, wherein a plurality of first apertures is formed through the edge member and the panel body, and wherein a plurality of second apertures is formed in the frame.

12. The container according to claim 11, further comprising a plurality of fasteners extending through the first and second apertures, thereby attaching the panel assembly to the frame.

13. The container according to claim 10, wherein the panel body is formed from a first material and the edge member is formed from a second material stronger than the first material.

14. The container according to claim 13, wherein the panel body is formed from resin reinforced with glass and the edge member is formed from resin reinforced with one of an aramid and a para-aramid material.

15. The container according to claim 10, wherein an array of sensors is embedded within the panel body.

16. The container according to claim 15, wherein the array of sensors includes one of an electrical sensor, an optical sensor, a chemical agent sensor, and a biological agent sensor.

17. The container according to claim 16, wherein the panel assembly includes an electrical connector connected to the array of sensors and extending outward of the panel body.

18. The container according to claim 17, wherein the array of sensors within each of two panel assemblies are connected by an electrical connector.

19. The container according to claim 10, wherein the frame includes a floor frame member having a floor frame wall assembly extending outwardly of the floor frame member and configured for attachment to the panel assembly;
wherein a floor frame panel is mounted to an inwardly facing surface of the floor frame wall assembly.

20. The container according to claim 19, wherein an array of sensors is embedded within the floor frame panel.

21. The container according to claim 20, wherein the array of sensors includes one of an electrical sensor, an optical sensor, a chemical agent sensor, and a biological agent sensor.

22. The container according to claim 21, wherein the floor frame panel includes an electrical connector connected to the array of sensors and extending outward of the floor frame panel.

23. The container according to claim 10, wherein the frame further includes:
a floor frame member; and
a floor panel assembly attached to the floor frame member;
wherein the floor panel assembly includes a first layer bonded to a second layer, the first layer formed from resin reinforced with glass, and the second layer formed from metal.

24. The container according to claim 23, wherein an array of sensors is embedded within the first layer of the floor panel assembly.

25. The container according to claim 24, wherein the array of sensors includes one of an electrical sensor, an optical sensor, a chemical agent sensor, and a biological agent sensor.

26. The container according to claim 25, wherein the floor panel assembly includes an electrical connector connected to the array of sensors and extending outward of the floor panel assembly.

27. A container comprising:
a frame including a plurality of two-part frame members, the two-part frame members having an inner frame and an outer frame, an interior space defined between the inner frame and the outer frame;
a plurality of panel assemblies, each panel assembly comprising:
a panel body having a major surface and a plurality of side surfaces, the major surface defining edge regions near an intersection of the major surface and the side surfaces; and
an edge member attached to an edge region of the panel body; an array of sensors embedded within each panel body; and
electrical connectors connecting the array of sensors of adjacent panel assemblies;
wherein the electrical connectors are contained within the interior space defined between the inner frame and the outer frame of the two-part frame members.

28. A method of forming a panel assembly configured for mounting to a container, the method comprising:
forming a panel body having a major surface and a plurality of side surfaces, the major surface defining edge regions near an intersection of the major surface and the side surfaces; and
bonding an edge member to an edge region of the panel body.

29. The method according to claim 28, further including the steps of:
forming the edge member by wrapping a portion of the panel body around a metal strip to define a wrapped metal member;
applying at least one layer of a thermoplastic resin composite reinforced by one of aramid fiber, para-aramid fiber, carbon fiber, and E-glass fiber to the wrapped metal member; and
heat forming the panel body and the edge member to define the panel assembly.
